(19) United States
(12) Patent Application Publication
(10) Pub. No.: US 2026/0126780 A1
(43) Pub. Date: May 7, 2026

(54) Migrating a Control Logic Type in a DCS

(71) Applicant: ABB Schweiz AG, Baden (CH)

(72) Inventors: Stefan Sallberg, Malmö (SE); Jeffrey Harding, Blowing Rock, NC (US); Hans Thilderkvist, Malmö (SE); Niklas Giheden, Svedala (SE)

(73) Assignee: ABB Schweiz AG, Baden (CH)

(21) Appl. No.: 19/379,878

(22) Filed: Nov. 5, 2025

(30) Foreign Application Priority Data
Nov. 5, 2024 (EP) 24210876

(51) Int. Cl. G05B 19/418

(52) U.S. Cl. CPC G05B 19/41825; G05B 19/4185

(57) ABSTRACT

A migrating a control logic type from a legacy engineering tool to a modern engineering tool in a DCS controlling devices in an industrial plant includes obtaining the control logic type in a legacy format from the legacy engineering tool; reformatting the control logic of the control logic type to a modern format compatible with the modern controller; copying the graphics instructions of the control logic type; updating the property list of the control logic type such that a format of a respective communication address field associated with each listed property is changed from a legacy format to a modern format compatible with the modern controller; and associating the reformatted control logic, the copied graphics instructions and the updated property list with a migrated control logic type in a library of the modern engineering tool.

### CROSS-REFERENCE TO RELATED APPLICATIONS

The instant application claims priority to European Patent Application No. 24210876.9, filed November 5, 2024, which is incorporated herein in its entirety by reference.

### FIELD OF THE DISCLOSURE

The present disclosure relates to migration of a control logic type from a legacy engineering tool to a modern engineering tool in a Distributed Control System (DCS) controlling devices in an industrial plant. The present disclosure also relates to a connectivity service in a DCS communicating with both legacy and modern controllers.

### BACKGROUND OF THE INVENTION

When updating the DCS of an industrial plant, from a legacy system to a modern system, such an update typically requires updating the complete system including all parts, like controllers, engineering tools and operator HMIs, at the same time, which is rather costly and time consuming.

For instance, US 2022/100527 discloses an updatable and backward compatible Programmable Logic Controller (PLC) with an instruction set library which can be partitioned to limit updates to only those used by the PLC.

### BRIEF SUMMARY OF THE INVENTION

Embodiments in accordance with the present disclosure facilitate introduction of modern controllers in an existing plant, without the need to exchange existing legacy controllers and/or Human-Machine Interface(s) (HMI) at the operator side in the plant. By copying the graphics instructions, without reformatting, and by updating the property list with the same identifiers but with a new, modern format of the respective communication address fields, a control logic type can be migrated from a legacy engineering tool to a modern engineering tool while still being compatible with already existing operator HMI. By means of a connectivity service, requests from an operator may be handled for both legacy and modern controllers in the same plant.

According to an aspect of the present disclosure, there is provided a method of migrating a control logic type from a legacy engineering tool to a modern engineering tool in a Distributed Control System (DCS) controlling devices in an industrial plant. The control logic type of the legacy engineering tool comprises a property list of identifiers of properties of a first type of device present among the controlled devices in the industrial plant, graphics instructions for a graphics window associated with the first type of device and based on at least some of the listed properties, and control logic using the listed properties for controlling the first type of device. The legacy engineering tool is usable for configuring respective instances of the control logic type for the devices of the first type which are controlled by a legacy controller. The modern engineering tool is usable for configuring respective instances of the control logic type for the devices of the first type which are controlled by a modern controller. The method comprises obtaining the control logic type in a legacy format from a library of the legacy engineering tool. The method also comprises reformatting the control logic of the obtained control logic type to a modern format compatible with the modern controller while keeping the identifiers of the properties unchanged. The method also comprises copying the graphics instructions of the obtained control logic type. The method also comprises updating the property list such that the identifiers of the listed properties therein are unchanged but a format of a respective communication address field associated with each listed property is changed from a legacy format to a modern format compatible with the modern controller. The method also comprises associating (or including) the reformatted control logic, the copied graphics instructions and the updated property list with (or in) a migrated control logic type in a library of the modern engineering tool.

According to another aspect of the present disclosure, there is provided a migration tool comprising processing circuitry, and storage storing instructions executable by said processing circuitry whereby said migration tool is operative to perform an embodiment of the method for migrating a control logic type, the method being in accordance with the present disclosure.

According to another aspect of the present disclosure, there is provided a computer program product comprising computer-executable components for causing a migration tool to perform an embodiment of the method for migrating a control logic type, the method being in accordance with the present disclosure, when the computer-executable components are run on processing circuitry comprised in the migration tool.

According to another aspect of the present disclosure, there is provided a DCS for controlling devices in an industrial plant. The DCS comprises a connectivity service holding, for each of the devices, a respective list of identifiers of properties of the device, each property in each of the lists being associated with an address for obtaining a present value of the property. The DCS also comprises at least one operator Human-Machine Interface (HMI), wherein each of which at least one operator HMI is arranged for presenting a respective graphics window for each of the devices which can be monitored by an operator via the operator HMI. The DCS also comprises a plurality of controllers, each controller being arranged to control at least one of the devices, at least one of the plurality of controllers being a legacy controller arranged for communication with the connectivity service via a legacy communication protocol, and at least one of the plurality of controllers being a modern controller arranged for communication with the connectivity service via a modern communication protocol. Each of the graphics windows is based on information about respective values of at least some of the listed properties of the device of the graphics window. The operator HMI is configured to update the graphics windows in respect of a first property of the properties on which the graphics window is based by sending a property request to the connectivity service. The property request includes a device ID identifying the device of the graphics window and an identifier of the first property. The connectivity service is configured to, in response to receiving the property request, determine, among the lists of properties, a property list of the device identified by the device ID in the property request. The connectivity service is also configured to, in response to receiving the property request, find the identifier of the first property in the determined list. The connectivity service is also configured to, in response to receiving the property request, obtain, by means of the address associated with the first property in the determined list, the present value of the first property by communication with the controller, of the plurality of controllers, controlling the identified device. The communication is via the legacy communication protocol if the controller is one of the at least one legacy controller and the communication is via the modern communication protocol if the controller is one of the at least one modern controller. The connectivity service is also configured to, in response to receiving the property request, send information about the obtained present value of the first property to the operator HMI.

According to another aspect of the present disclosure, there is provided a method performed by a connectivity service in a DCS. The method comprises receiving a property request from an operator HMI in the DCS. The property request includes a device ID identifying a device of a graphics window which the operator HMI is arranged to present for the device. The property request also includes an identifier of a first property of a plurality of properties of the device on which the graphics window is based. The method also comprises, among lists of properties held by the connectivity service, wherein each of the lists relates to a respective device controlled by the DCS, determining a property list of the device identified by the device ID in the received property request. The method also comprises, in the determined property list, in which property list each listed property is associated with an address for obtaining a present value of the property, finding the identifier of the first property. The method also comprises, by means of the address associated with the found identifier, obtaining the present value of the first property by communication with the controller, of the plurality of controllers, which controller is controlling the identified device. The communication is via a legacy communication protocol if the controller is a legacy controller and wherein the communication is via a modern communication protocol if the controller is a modern controller. The method also comprises, sending information about the obtained present value of the first property to the operator HMI.

According to another aspect of the present disclosure, there is provided a connectivity service comprising processing circuitry, and storage storing instructions executable by said processing circuitry whereby said connectivity service is operative to perform an embodiment of the method performed by a connectivity service, the method being in accordance with the present disclosure.

According to another aspect of the present disclosure, there is provided a DCS comprising an embodiment of the connectivity service of the present disclosure, at least one operator HMI of the present disclosure and a plurality of controllers of the present disclosure.

According to another aspect of the present disclosure, there is provided a computer program product comprising computer-executable components for causing a connectivity service to perform an embodiment of the method performed by a connectivity service, the method being in accordance with the present disclosure, when the computer-executable components are run on processing circuitry comprised in the connectivity service.

### BRIEF DESCRIPTION OF THE SEVERAL VIEWS OF THE DRAWING(S)

FIG. 1 is a schematic block diagram of a DCS of an industrial plant, in accordance with some embodiments of the present disclosure.

FIG. 2 is a schematic block diagram of an engineering tool for producing instances of different control logic types for an industrial plant, in accordance with some embodiments of the present disclosure.

FIG. 3 is a schematic block diagram of a control logic type, in accordance with some embodiments of the present disclosure.

FIG. 4 is a schematic block diagram of a property list of a control logic type, in accordance with some embodiments of the present disclosure.

FIG. 5 is a schematic block diagram of a migration tool for migrating a control logic type from a legacy engineering tool to a modern engineering tool in a DCS, in accordance with some embodiments of the present disclosure.

FIG. 6 is a schematic flow chart of a method of migrating a control logic type from a legacy engineering tool to a modern engineering tool in a DCS, in accordance with some embodiments of the present disclosure.

FIG. 7 is a schematic block diagram of a DCS controlling devices in an industrial plant, in accordance with some embodiments of the present disclosure.

FIG. 8 is a schematic block diagram of a connectivity service of/in a DCS, in accordance with some embodiments of the present disclosure.

FIG. 9 is a schematic block diagram of a property request send from an operator HMI to the connectivity service, in accordance with some embodiments of the present disclosure.

FIG. 10 is a schematic flow chart of a method performed by/in a connectivity service in a DCS, in accordance with some embodiments of the present disclosure.

### DETAILED DESCRIPTION OF THE INVENTION

When adding a device, e.g. a pump or a tank, to an industrial plant, the DCS of the plant is updated for controlling the device. This is typically done by an engineer (i.e. user of the engineering tool) via an engineering tool of (in or connected to) the DCS. An engineering tool may be software (SW) which runs on any computer, e.g. at a provider of the DCS or at an operator of the plant which may be a customer to the provider, on in a computing cloud. To avoid having to start from scratch every time the DCS is updated with a new device, the engineering tool may list several control logic types, e.g. one type for pumps and another type for tanks, which may be used as templates by the engineer when updating the DCS. The engineer may then create several instances of a type, one per device associated with the type, e.g. a first instance created from a pump type, configured for controlling a first pump in the plant, and a second instance created from the same pump type, configured for controlling a second pump in the plant.

Each control logic type listed in the engineering tool comprises a property list of respective identifiers of properties of the type of devices, e.g. pumps or tanks, which the control logic type relates to. Each identifier may e.g. be a name of the property or a string of symbols (e.g. alphanumerical) identifying the property. The properties may comprise e.g. constant properties such as volume of a tank, max or min speed of a motor or pump etc., and variable properties which may be measured or calculated such as current fill level in a tank, current speed of a motor or pump etc.

Each control logic type also comprises a graphics instructions for a graphics window associated with the type of device and based on at least some of the properties listed in the property list. An operator HMI in the plant may present a respective graphics window of each, or a sub-group, of the devices of the type present in the plant, e.g. one graphics window for the first pump and one graphics window for the second pump, where the information presented in the graphics window is based on all or some of the properties listed in the property list. For presenting information based on a current value of a variable property of a device, the operator HMI may need to send a property request to the controller controlling the device, via a connectivity service in accordance with some embodiments of the present disclosure, and in response receive information about the requested current value from the controller. A new request may be sent each time the graphics window is updated, e.g. by automatic updating or by the operator updating the window.

Each control logic type also comprises control logic which uses the listed properties for controlling the type of device. The control logic of an instance of the control logic type may be loaded onto the controller which is appointed to control the device of the instance.

Each device is typically controlled by a respective controller. Each controller may control one or several of the devices in the plant. As discussed herein, both legacy and modern controllers may be used at the same time in the plant. That a controller in the plant is modern indicates that it is updated, or of a later configuration, in relation to the legacy controller(s) of the plant. A legacy controller may be configured to communicate with the connectivity service, and/or other parts of the DCS, by means of a legacy communication protocol, for instance in accordance with Open Platform Communications (OPC) Classic specifications e.g. OPC Data Access (DA) and/or in accordance with Manufacturing Message Specification (MMS). Additionally or alternatively, a modern controller may be configured to communicate with the connectivity service, and/or other parts of the DCS, by means of a modern communication protocol, for instance in accordance with OPC Unified Architecture (UA) specifications.

FIG. 1 illustrates a DCS 1 for controlling devices 11 in an industrial plant 10. The DCS 1 comprises an engineering tool system 4 and a plurality of controllers 5, here at least one legacy controller 5a and at least one modern controller 5b. Each of the controllers 5 controls at least one device 11 of the devices in the industrial plant 10.

The engineering tool system 4 comprises a legacy engineering tool 2a and a modern engineering tool 2b, where the legacy engineering tool 2a is configured for producing instances of a control logic type for a legacy controller 5a, and where the modern engineering tool 2b is configured for producing instances of the control logic type for a modern controller 5b. The engineering tool system 4 also comprises a migration tool 3 for performing the method of migrating a control logic type from the legacy engineering tool 2a to the modern engineering tool 2b.

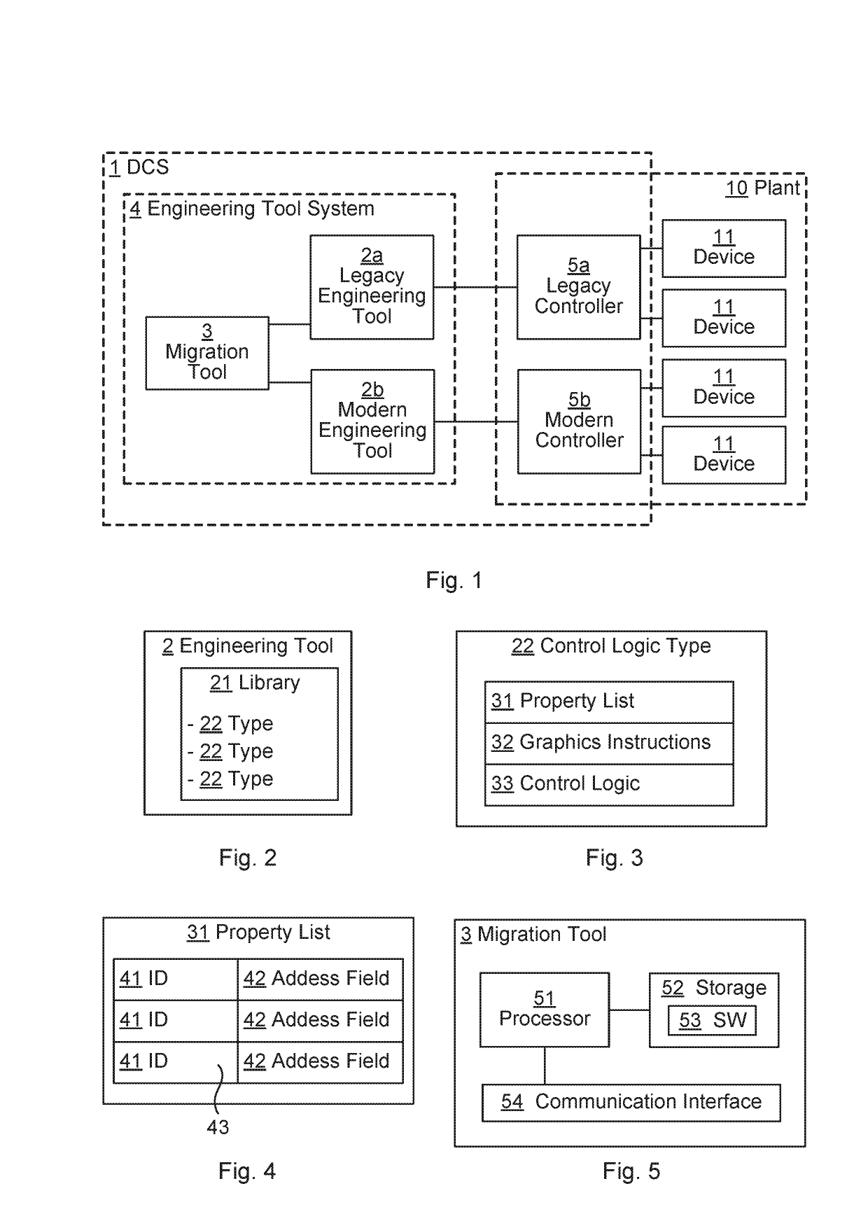

FIG. 2 illustrates an engineering tool 2, e.g. a legacy engineering tool 2a or a modern engineering tool 2b. The engineering tool comprises a library in which a plurality of different control logic types 22 are listed and selectable by a user of the engineering tool. The listed control logic types 22 may e.g. comprise a pump type, a motor type and/or a tank type, as exemplified above, or any other type of device 11. The user of the engineering tool may select one of the control logic types 22 and produce one or more instances of it for respective devices 11 of a device type corresponding to the selected control logic type 22.

FIG. 3 illustrates a control logic type 22. As discussed above, the control logic type 22 comprises a property list 31, graphics instructions 32 and control logic 33 for a device 11 of the device type corresponding to the control logic type 22.

FIG. 4 illustrates a property list 31. The property list 31 comprises a list of identifiers (ID), e.g. names, of listed properties 43 of the device type the control logic type 22 of the property list 31 relates to. Each of the identifiers is associated with a respective communication address field 42, whereby each listed property 43 is associated with said respective communication address field 42. If the property list is in a control logic type 22 configured for a legacy engineering tool 2a, the communication address field 42 is in a legacy format, i.e. in an address format for obtaining a value of the property 43 from a legacy controller 5a. Correspondingly, if the property list is in a control logic type 22 configured for a modern engineering tool 2b, the communication address field 42 is in a modern format, i.e. in an address format for obtaining a value of the property 43 from a modern controller 5b.

FIG. 5 illustrates a migration tool 3 of the engineering tool system 4. The migration tool 3 may run SW 53 for performing the method of migrating a control logic type 22 from a legacy engineering tool 2a to a modern engineering tool 2b. The migration tool 3 comprises processing circuitry 51 e.g. a central processing unit (CPU). The processing circuitry 51 may comprise one or a plurality of processing units in the form of microprocessor(s). However, other suitable devices with computing capabilities could be comprised in the processing circuitry 51, e.g. an application specific integrated circuit (ASIC), a field programmable gate array (FPGA) or a complex programmable logic device (CPLD). The processing circuitry 51 is configured to run one or several computer program(s) or software (SW) 53 stored in a storage 52 of one or several storage unit(s) e.g. a memory. The storage unit is regarded as a computer readable means 52, forming a computer program product together with the SW 53 stored thereon as computer-executable components and may e.g. be in the form of a Random Access Memory (RAM), a Flash memory or other solid state memory, or a hard disk, or be a combination thereof. The processing circuitry 51 may also be configured to store data in the storage 52, as needed. The migration tool 3 also comprises a communication interface 54, e.g. for communication with the legacy engineering tool 2a and the modern engineering tool 2b.

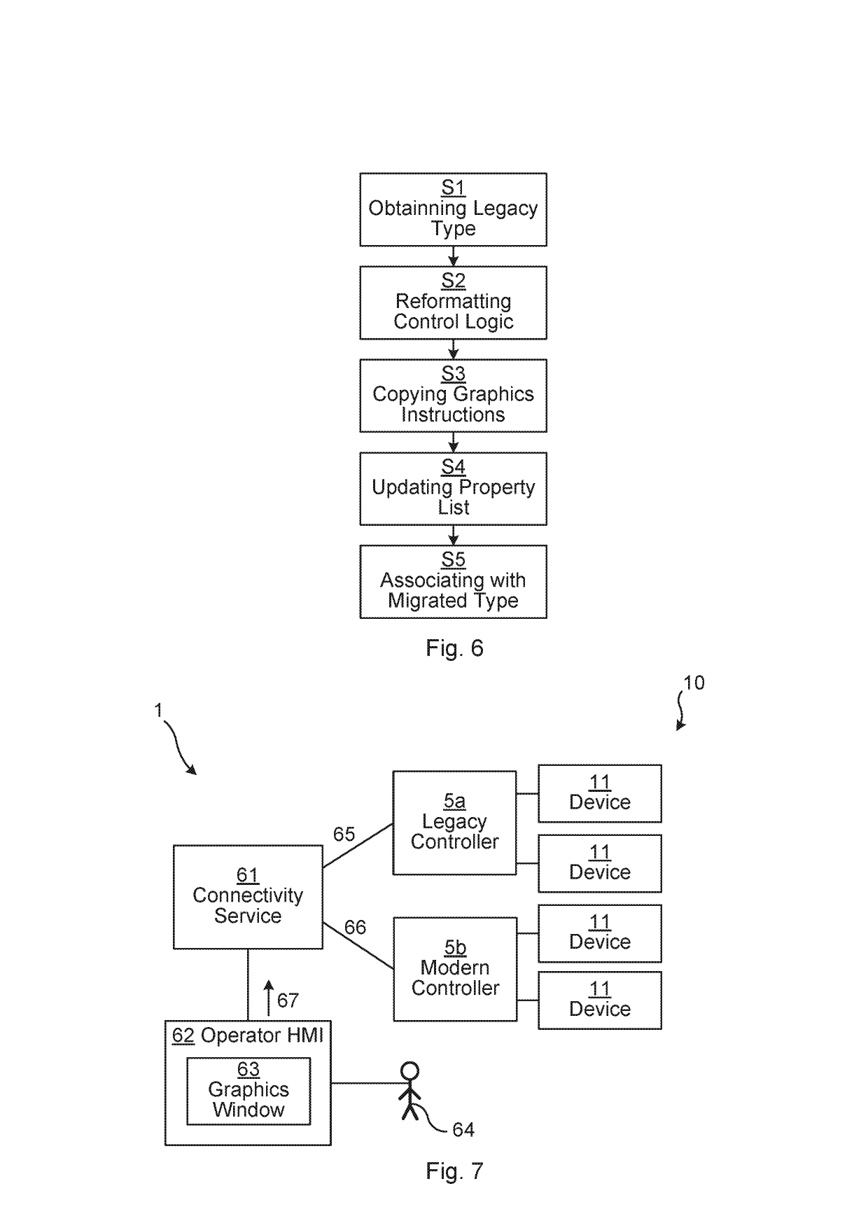

FIG. 6 illustrates a method of migrating a control logic type 22 from a legacy engineering tool 2a to a modern engineering tool 2b in a Distributed Control System (DCS) 1, which DCS controls devices 11 in an industrial plant 10.

The control logic type 22 of the legacy engineering tool 2a comprises a property list 31 of identifiers 41 of properties 43 of a first type of device present among the controlled devices 11 in the industrial plant 10, graphics instructions 32 for a graphics window 63 associated with the first type of device 11 and based on at least some of the listed properties, and control logic 33 using the listed properties 43 for controlling the first type of device 11. The legacy engineering tool 2a is usable for configuring respective instances of the control logic type 22 for the devices 11 of the first type which are controlled by a legacy controller 5a. The modern engineering tool 2b is usable for configuring respective instances of the control logic type 22 for the devices 11 of the first type which are controlled by a modern controller 5b.

The method comprises obtaining S1 the control logic type 22 in a legacy format from a library 21 of the legacy engineering tool 2a. Then, the control logic 33 of the obtained S1 control logic type 22 is reformatted S2 to a modern format compatible with the modern controller 5b while keeping the identifiers 41 of the properties 43 unchanged. By keeping the identifiers 41 of the properties 43 unchanged in both the control logic 33 and in the property list, the control logic type may remain compatible with the operator HMI 62, e.g. allowing the operator HMI 62 send property requests 67 in the same way as before, regardless of whether the request relates to a device 11 which is controlled by a legacy controller 5a or a modern controller 5b. The graphics instructions 32 of the obtained S1 control logic type 22 are copied S3, e.g. to a legacy system within the DCS 1. By copying the graphics instructions, i.e. keeping the graphics instructions 32 of the modern engineering tool 2b the same as in the legacy engineering tool 2a, the operator HMI 62 using the graphics instructions can remain unaffected and agnostic. The property list 31 is updated S4 such that the identifiers 41 of the listed properties 43 therein are unchanged but a format of a respective communication address field 42 associated with each listed property is changed from a legacy format to a modern format compatible with the modern controller 5b. Again, by keeping the identifiers 41 of the properties 43 unchanged in both the control logic 33 and in the property list, the control logic type may remain compatible with the operator HMI 62, e.g. allowing the operator HMI 62 send property requests 67 in the same way as before, regardless of whether the request relates to a device 11 which is controlled by a legacy controller 5a or a modern controller 5b. By changing the respective communication address field 42 associated with each listed property 43 (i.e. each listed ID 41) from a legacy format to a modern format compatible with the modern controller 5b, the property list 31 is made compatible with a modern controller 5b. Then, the reformatted S2 control logic 33, the copied S3 graphics instructions 32 and the updated S4 property list 31 is associated S5 with (included in/made part of) a new, migrated control logic type 22 in a library 21 of the modern engineering tool 2b. Thus, also the migrated control logic type 22 comprises the three parts of a property list 31, graphics instructions 32, and control logic 33, though all parts may not need to be stored together in e.g. the modern engineering tool 2b. For instance, the copied S3 graphics instructions 32 may be stored in a legacy system of the DCS 1 and/or the updated S4 property list 31 may be stored in either or both of a legacy system of the DCS 1 and a modern system of the DCS 1 (e.g. in the modern engineering tool 2b).

A general aspect of the present disclosure relates to a migrating a control logic type from a legacy engineering tool 2a to a modern engineering tool 2b in a DCS 1 controlling devices 11 in an industrial plant 10. It comprises obtaining the control logic type in a legacy format from the legacy engineering tool; reformatting the control logic of the control logic type to a modern format compatible with the modern controller 5b; copying the graphics instructions of the control logic type; updating the property list of the control logic type such that a format of a respective communication address field associated with each listed property is changed from a legacy format to a modern format compatible with the modern controller; and associating the reformatted control logic, the copied graphics instructions and the updated property list with a migrated control logic type in a library of the modern engineering tool.

FIG. 7 illustrates the DCS 1 during operation when controlling the devices 11 of the plant 10. An operator 64 may monitor the devices 11 via the operator HMI 62 displaying respective graphics windows 63 for the devices 11. For updating a value of a property 43 of a device 11 on which a graphics window 63 of that device 11 is based, the operator HMI 62 sends a property request 67 to a connectivity service 61 of the DCS 1. As illustrated in FIG. 9, the property request 67 comprises a device ID 81 identifying the device 11 of the graphics window 63, and the identifier 41 of the property 43 whose value is being updated. Based on the device ID 81 and the property identifier 41, the connectivity service 61 is able to obtain the address for obtaining the requested value of the property 43, including from which controller 5 regardless of whether the controller is a legacy controller 5a or a modern controller 5b. The requested value of the property 43 is obtained by communication with the controller 5 controlling the device 11. If the controller 5 is a legacy controller 5a, the communication is via (or by means of) a legacy communication protocol 65. If the controller 5 is a modern controller 5b, the communication is via (or by means of) a modern communication protocol 66.

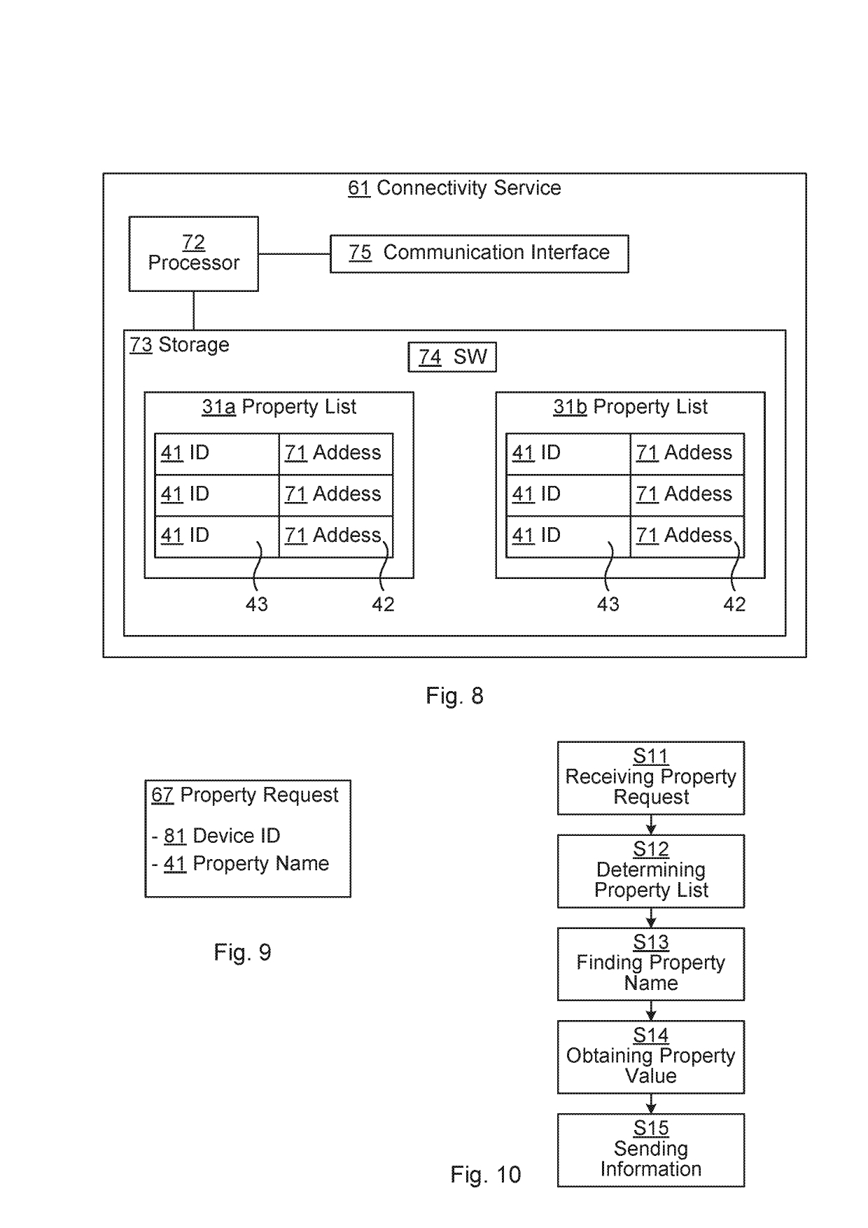

FIG. 8 illustrates a connectivity service 61. The connectivity service 61 stores, in a data storage 73, a respective property list 31 of each of the devices 11 in the plant 10. As discussed before, each of the property lists 31 lists identifiers 41 of properties 43 of the device 11 of the property list 31. However, since the property list 31 is not of a control logic type 22, as in FIG. 3, but of an instance produced from such a control logic type 22, the communication address field 42 associated with each identifier 41 is filled with an address 71 for where to find the (current) value of the property 43 identified by the identifier 41. If the device 11 of the property list 31 is controlled by a legacy controller 5a, the address 71 of each communication address field 42 is in accordance with the legacy format of the communication address field 42. If the device 11 of the property list 31 is controlled by a modern controller 5b, the address 71 of each communication address field 42 is in accordance with the modern format of the communication address field 42. Thus, the connectivity service 61 can direct the property request 67 to the correct controller 5, and obtain the property value there from, regardless of whether the controller is a legacy controller 5a or a modern controller 5b, while keeping the operator HMI 62 agnostic.

The connectivity service 61 comprises processing circuitry 72 e.g. a central processing unit (CPU). The processing circuitry 72 may comprise one or a plurality of processing units in the form of microprocessor(s). However, other suitable devices with computing capabilities could be comprised in the processing circuitry 72, e.g. an application specific integrated circuit (ASIC), a field programmable gate array (FPGA) or a complex programmable logic device (CPLD). The processing circuitry 72 is configured to run one or several computer program(s) or software (SW) 74 stored in the storage 73 of one or several storage unit(s) e.g. a memory. The storage unit is regarded as a computer readable means 73, forming a computer program product together with the SW 74 stored thereon as computer-executable components and may e.g. be in the form of a Random Access Memory (RAM), a Flash memory or other solid state memory, or a hard disk, or be a combination thereof. The processing circuitry 72 may also be configured to store data in the storage 73, as needed. The connectivity service 61 also comprises a communication interface 75 for communicating with other parts of the DCS 1, e.g. with the operator HMI 62 and with the legacy and modern controllers 5.

FIG. 10 illustrates some embodiments of a method performed by a connectivity service 61 in a DCS 1. The method comprises receiving S11 a property request 67 from an operator HMI 62 in the DCS. The property request 67 includes a device ID 81 identifying a device 11 of a graphics window 63 which the operator HMI is arranged to present for the device, and an identifier 41 of a first property 43 of a plurality of properties of the device on which the graphics window is based. The method also comprises, among lists 31 of properties 43 held by the connectivity service 61, each of the lists relating to a respective device 11 controlled by the DCS 1, determining S12 a property list of the device identified by the device ID 81 in the received S11 property request 67. The method also comprises, in the determined S12 property list 31, in which each listed property 43 is associated with an address 71 for obtaining a present value of the property, finding S13 the identifier 41 of the first property 43. The method also comprises, by means of the address 71 associated with the found S13 identifier 41, obtaining S14 the present value of the first property 43 by communication with the controller, of the plurality of controllers 5, which controller controls the identified device 11. The communication is via a legacy communication protocol 65 if the controller is a legacy controller 5a and the communication is via a modern communication protocol 66 if the controller is a modern controller 5b. The method also comprises sending S15 information about the obtained S14 present value of the first property 43 to the operator HMI 62.

All references, including publications, patent applications, and patents, cited herein are hereby incorporated by reference to the same extent as if each reference were individually and specifically indicated to be incorporated by reference and were set forth in its entirety herein.

The use of the terms “a” and “an” and “the” and “at least one” and similar referents in the context of describing the invention (especially in the context of the following claims) are to be construed to cover both the singular and the plural, unless otherwise indicated herein or clearly contradicted by context. The use of the term “at least one” followed by a list of one or more items (for example, “at least one of A and B”) is to be construed to mean one item selected from the listed items (A or B) or any combination of two or more of the listed items (A and B), unless otherwise indicated herein or clearly contradicted by context. The terms “comprising,” “having,” “including,” and “containing” are to be construed as open-ended terms (i.e., meaning “including, but not limited to,”) unless otherwise noted. Recitation of ranges of values herein are merely intended to serve as a shorthand method of referring individually to each separate value falling within the range, unless otherwise indicated herein, and each separate value is incorporated into the specification as if it were individually recited herein. All methods described herein can be performed in any suitable order unless otherwise indicated herein or otherwise clearly contradicted by context. The use of any and all examples, or exemplary language (e.g., “such as”) provided herein, is intended merely to better illuminate the invention and does not pose a limitation on the scope of the invention unless otherwise claimed. No language in the specification should be construed as indicating any non-claimed element as essential to the practice of the invention.

Preferred embodiments of this invention are described herein, including the best mode known to the inventors for carrying out the invention. Variations of those preferred embodiments may become apparent to those of ordinary skill in the art upon reading the foregoing description. The inventors expect skilled artisans to employ such variations as appropriate, and the inventors intend for the invention to be practiced otherwise than as specifically described herein. Accordingly, this invention includes all modifications and equivalents of the subject matter recited in the claims appended hereto as permitted by applicable law. Moreover, any combination of the above-described elements in all possible variations thereof is encompassed by the invention unless otherwise indicated herein or otherwise clearly contradicted by context.

What is claimed is:

1. A method of migrating a control logic type from a legacy engineering tool to a modern engineering tool in a Distributed Control System (DCS) controlling devices in an industrial plant, wherein the control logic type of the legacy engineering tool comprises a property list of identifiers of properties of a first type of device present among the controlled devices in the industrial plant, graphics instructions for a graphics window associated with the first type of device and based on at least some of the listed properties, and control logic using the listed properties for controlling the first type of device; wherein the legacy engineering tool is usable for configuring respective instances of the control logic type for the devices of the first type which are controlled by a legacy controller; and wherein the modern engineering tool is usable for configuring respective instances of the control logic type for the devices of the first type which are controlled by a modern controller, the method comprising:
obtaining the control logic type in a legacy format from a library of the legacy engineering tool;
reformatting the control logic of the obtained control logic type to a modern format compatible with the modern controller while keeping the identifiers of the properties unchanged;
copying the graphics instructions of the obtained control logic type;
updating the property list such that the identifiers of the listed properties therein are unchanged but a format of a respective communication address field associated with each listed property is changed from a legacy format to a modern format compatible with the modern controller; and
associating the reformatted control logic, the copied graphics instructions and the updated property list with a migrated control logic type in a library of the modern engineering tool.

2. The method of claim 1, wherein the modern format of the address field is in accordance with Open Platform Communications (OPC) Unified Architecture (UA) specifications.

3. The method of claim 1, wherein the legacy format of the address field is in accordance with OPC Classics specifications and/or in accordance with Manufacturing Message Specification (MMS).

4. A computer program product comprising computer-executable instructions for causing a migration tool to perform a method of migrating a control logic type from a legacy engineering tool to a modern engineering tool in a Distributed Control System (DCS) controlling devices in an industrial plant, wherein the control logic type of the legacy engineering tool comprises a property list of identifiers of properties of a first type of device present among the controlled devices in the industrial plant, graphics instructions for a graphics window associated with the first type of device and based on at least some of the listed properties, and control logic using the listed properties for controlling the first type of device; wherein the legacy engineering tool is usable for configuring respective instances of the control logic type for the devices of the first type which are controlled by a legacy controller; and wherein the modern engineering tool is usable for configuring respective instances of the control logic type for the devices of the first type which are controlled by a modern controller, the computer program comprising:
instructions for obtaining the control logic type in a legacy format from a library of the legacy engineering tool;
instructions for reformatting the control logic of the obtained control logic type to a modern format compatible with the modern controller while keeping the identifiers of the properties unchanged;
instructions for copying the graphics instructions of the obtained control logic type;
instructions for updating the property list such that the identifiers of the listed properties therein are unchanged but a format of a respective communication address field associated with each listed property is changed from a legacy format to a modern format compatible with the modern controller; and
instructions for associating the reformatted control logic, the copied graphics instructions and the updated property list with a migrated control logic type in a library of the modern engineering tool.

5. A Distributed Control System (DCS) for controlling devices in an industrial plant, the DCS comprising:
a connectivity service holding, for each of the devices, a respective list of identifiers of properties of the device, each property in each of the lists being associated with an address for obtaining a present value of the property;
at least one operator Human-Machine Interface (HMI) each of which at least one operator HMI is arranged for presenting a respective graphics window for each of the devices which can be monitored by an operator via the operator HMI; and
a plurality of controllers, each controller being arranged to control at least one of the devices, at least one of the plurality of controllers being a legacy controller arranged for communication with the connectivity service via a legacy communication protocol, and at least one of the plurality of controllers being a modern controller arranged for communication with the connectivity service via a modern communication protocol;
wherein each of the graphics windows is based on information about respective values of at least some of the listed properties of the device of the graphics window, wherein the operator HMI is configured to update the graphics windows in respect of a first property of the properties on which the graphics window is based by sending a property request to the connectivity service, the property request including a device ID identifying the device of the graphics window and an identifier of the first property; and
wherein the connectivity service is configured to, in response to receiving the property request:
among the lists of properties, determine a property list of the device identified by the device ID in the property request,
find the identifier of the first property in the determined list,
using the address associated with the first property in the determined list, obtain the present value of the first property by communication with the controller, of the plurality of controllers, controlling the identified device, wherein the communication is via the legacy communication protocol when the controller is one of the at least one legacy controller and wherein the communication is via the modern communication protocol when the controller is one of the at least one modern controller, and
send information about the obtained present value of the first property to the operator HMI.

6. The DCS of claim 5, wherein the legacy communication protocol is in accordance with Open Platform Communications (OPC), Classic specifications, and/or in accordance with Manufacturing Message Specification (MMS).

7. The DCS of claim 6, wherein the modern communication protocol is in accordance with OPC Unified Architecture (UA) specifications.

8. A method performed by a connectivity service in a DCS, the method comprising:
receiving a property request from an operator HMI in the DCS, the property request including a device ID identifying a device of a graphics window which the operator HMI is arranged to present for the device, and an identifier of a first property of a plurality of properties of the device on which the graphics window is based;
among lists of properties held by the connectivity service, each of the lists relating to a respective device controlled by the DCS, determining a property list of the device identified by the device ID in the received property request;
in the determined property list, in which each listed property is associated with an address for obtaining a present value of the property, finding the identifier of the first property;
using the address associated with the found identifier, obtaining the present value of the first property by communication with the controller, of the plurality of controllers, controlling the identified device, wherein the communication is via a legacy communication protocol when the controller is a legacy controller and wherein the communication is via a modern communication protocol when the controller is a modern controller; and
sending information about the obtained present value of the first property to the operator HMI.
